(19) United States
(12) Patent Application Publication
(10) Pub. No.: US 2024/0142856 A1
(43) Pub. Date: May 2, 2024

(54) LENS DRIVING APPARATUS AND CAMERA MODULE INCLUDING LENS DRIVING APPARATUS

(71) Applicant: Samsung Electro-Mechanics Co., Ltd., Suwon-si (KR)

(72) Inventors: Ju Ho KIM, Suwon-si (KR); Donghoon LEE, Suwon-si (KR); Dooseub SHIN, Suwon-si (KR); Sanghyun JI, Suwon-si (KR); Dohwan KIM, Suwon-si (KR)

(73) Assignee: Samsung Electro-Mechanics Co., Ltd., Suwon-si (KR)

(21) Appl. No.: 18/378,793

(22) Filed: Oct. 11, 2023

(30) Foreign Application Priority Data
Nov. 2, 2022 (KR) 10-2022-0144627
Apr. 27, 2023 (KR) 10-2023-0055553

(51) Int. Cl. G03B 5/02; G03B 3/10; G03B 5/04; G03B 13/36; G03B 17/12

(52) U.S. Cl. CPC G03B 5/02; G03B 3/10; G03B 5/04; G03B 13/36; G03B 17/12; G03B 2205/0007; G03B 2205/0061

(57) ABSTRACT

A lens driving apparatus includes a first frame accommodating a lens barrel, a first optical image stabilization (OIS) driver including a first frictional contact portion disposed on the first frame, a first piezoelectric element configured to vibrate in a first direction, and a first rod connected to a first end of the first piezoelectric element, in contact with the first frictional contact portion, and configured to move the first frame in the first direction, and a second OIS driver that including a second frictional contact portion disposed on the first frame, a second piezoelectric element configured to vibrate in a second direction different from the first direction, and a second rod connected to a first end of the second piezoelectric element, in contact with the second frictional contact portion, and configured to move the first frame in the second direction.

### CROSS-REFERENCE TO RELATED APPLICATIONS

This application claims the benefit under 35 USC 119(a) of Korean Patent Application Nos. 10-2022-0144627 filed on Nov. 2, 2022, and 10-2023-0055553 filed on Apr. 27, 2023, in the Korean Intellectual Property Office, the entire disclosures of which are incorporated herein by reference for all purposes.

### BACKGROUND

### 1. Field

The present disclosure relates to a lens driving apparatus and a camera module including a lens driving apparatus.

### 2. Description of Related Art

With remarkable development of information communication technology and semiconductor technology, distribution and use of electronic devices is rapidly increasing. Recently, a camera has been a basic feature in a portable electronic device such as a smartphone, a tablet PC, and a laptop computer, and an autofocus (AF) function, an image stabilization (IS) function, and a zoom function may be added to the camera of this portable electronic device.

The image stabilization (IS) function may include camera shake compensation and/or hand shake compensation, and an image of a photographed subject may be prevented from vibrating due to an unintentional occurrence of hand shake or camera shake by a photographer when the camera is moving or stationary.

The autofocus (AF) function is to obtain a clear image from an imaging plane of an image sensor by moving a lens positioned in front of the image sensor in an optical axis direction depending on a distance from the subject.

A voice coil motor (VCM) is mainly used as a small driving device for implementing an image stabilization function and an autofocus function. However, power consumption of such a VCM may greatly increase as the weight and size of the lens increase.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a lens driving apparatus includes a first frame accommodating a lens; a first optical image stabilization (OIS) driver including a first frictional contact portion disposed on the first frame, a first piezoelectric element configured to vibrate in a first direction, and a first rod connected to a first end of the first piezoelectric element, in contact with the first frictional contact portion, and configured to move the first frame in the first direction; and a second OIS driver including a second frictional contact portion disposed on the first frame, a second piezoelectric element configured to vibrate in a second direction different from the first direction, and a second rod connected to a first end of the second piezoelectric element, in contact with the second frictional contact portion, and configured to move the first frame in the second direction.

The first frictional contact portion may be disposed on a first contact surface of the first frame, and the second frictional contact portion may be disposed on a second contact surface of the first frame, and the first contact surface and the second contact surface may be perpendicular to each other.

The first contact surface may be parallel to the first direction, and the second contact surface may be parallel to the second direction.

The first OIS driver may further include a first hinge member having a first end connected to a second end of the first piezoelectric element, and a second end connected to a second frame accommodating the first frame, and the second OIS driver may further include a second hinge member having a first end connected to a second end of the second piezoelectric element, and a second end connected to the second frame.

The lens driving apparatus may further include a lens holder accommodating a lens barrel accommodating the lens, wherein the first frame may be a carrier accommodating the lens holder.

The second frame may be a housing accommodating the carrier.

The lens driving apparatus may further include a supporting frame disposed between the carrier and the housing; a first ball assembly configured to guide movement of the carrier in the first direction by the first OIS driver; a second ball assembly configured to guide movement of the carrier in the second direction by the second OIS driver; a first guide groove assembly formed on surfaces of the carrier and the supporting frame facing each other having the first ball assembly disposed therein; and a second guide groove assembly formed on surfaces of the supporting frame and the housing facing each other and having the second ball assembly disposed therein.

Aa second end of the first hinge member may be connected to a surface of the housing parallel to the second direction, and a second end of the second hinge member may be connected to a surface of the housing parallel to the first direction.

The first frictional contact portion may be coupled to a first accommodation portion disposed in a first edge portion of the carrier, and the second frictional contact portion may be coupled to a second accommodation portion disposed in a second edge portion of the carrier.

Each of the first frictional contact portion and the second frictional contact portion may include a friction clamp.

Each of the first accommodation portion and the second accommodation portion may be a groove accommodating the friction clamp, and the first frictional contact portion and the first accommodation portion may be coupled in the first direction, and the second frictional contact portion and the second accommodation portion may be coupled in the second direction.

The first hinge member may be coupled to a portion of a housing parallel to the first direction, and the second hinge member may be coupled to a portion of the housing parallel to the second direction.

The lens driving apparatus may further include an AF driver including a third frictional contact portion disposed on the lens holder; a third rod in contact with the third frictional contact portion; and a third piezoelectric element having a first end connected to the carrier and a second end connected to a first end of the third rod and being configured to vibrate in a direction perpendicular to the first direction and the second direction.

The first frame may be a lens holder accommodating the lens barrel, and the second frame may be a carrier accommodating the lens holder.

The lens driving apparatus may further include an AF driver including a third frictional contact portion disposed on the carrier; a third rod in contact with the third frictional contact portion; and a third piezoelectric element connected to a first end of the third rod and configured to vibrate in a direction perpendicular to the first direction and the second direction.

In another general aspect, a camera module includes a lens; a lens barrel accommodating the lens; a first frame accommodating the lens barrel; a second frame accommodating the first frame; a first OIS driver including a first frictional contact portion disposed on the first frame, a first piezoelectric element configured to vibrate in a first direction, a first rod connected to a first end of the first piezoelectric element, in contact with the first frictional contact portion, and configured to move the first frame in the first direction, and a first hinge member having a first end connected to a second end of the first piezoelectric element and a second end connected to the second frame; and a second OIS driver including a second frictional contact portion disposed on the first frame, a second piezoelectric element configured to vibrate in a second direction different from the first direction, a second rod connected to a first end of the second piezoelectric element, in contact with the second frictional contact portion, and configured to move the first frame in the second direction, and a second hinge member having a first end connected to a second end of the second piezoelectric element and a second end connected to the second frame.

The camera module may further include a lens holder accommodating the lens barrel, wherein the first frame is a carrier accommodating the lens holder, and the second frame is a housing accommodating the carrier.

The first frictional contact portion may be connected to a surface of the carrier parallel to the first direction, and the second frictional contact portion may be connected to a surface of the carrier parallel to the second direction, and the first hinge member may be connected to a surface of the housing parallel to the first direction, and the second hinge member may be connected to a surface of the housing parallel to the second direction.

The first frictional contact portion may be connected to a surface of the carrier parallel to the first direction, and the second frictional contact portion may be connected to a surface of the carrier parallel to the second direction, and the first hinge member may be connected to a surface of the housing parallel to the second direction, and the second hinge member may be connected to a surface of the housing parallel to the first direction.

The first frame may be a lens holder accommodating the lens barrel, and the second frame may be a carrier accommodating the lens holder.

Other features and aspects will be apparent from the following detailed description, the drawings, and the claims.

### BRIEF DESCRIPTION OF DRAWINGS

FIG. 1 is a perspective view illustrating an appearance of a camera module according to an embodiment with a cover separated.

FIG. 2 is an exploded perspective view schematically illustrating the camera module shown in FIG. 1.

FIG. 3 is a schematic view illustrating an OIS driver of the camera module shown in FIG. 2.

FIG. 4 is a partial exploded view illustrating first and second OIS drivers of the camera module shown in FIG. 2.

FIG. 5 is a perspective view showing a part where the housing of the camera module and the OIS driver shown in FIG. 2 are coupled.

FIG. 6 is a perspective view showing a part where the carrier of the camera module and the OIS driver shown in FIG. 2 are coupled.

FIG. 7 is a perspective view showing a part where the housing and the carrier of the camera module and the OIS driver shown in FIG. 2 are coupled.

FIG. 8 is a perspective view of a part where the carrier and the lens holder of the camera module and the AF driver shown in FIG. 2 are coupled.

FIG. 9 is a partially exploded perspective view illustrating a lens holder, a carrier, and an AF driver to describe a camera module according to another embodiment.

FIG. 10 illustrates a camera module according to another embodiment.

FIG. 11 illustrates a camera module according to another embodiment.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

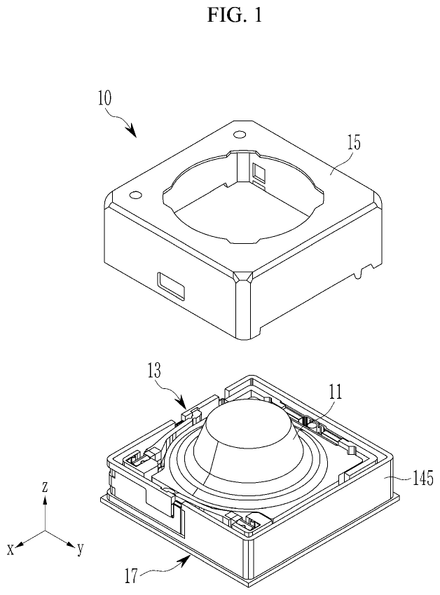

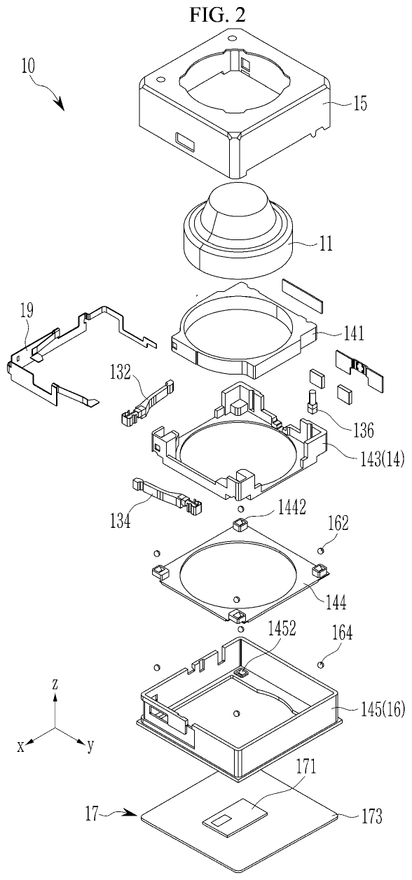

FIG. 1 is a perspective view illustrating an appearance of a camera module according to an embodiment with a cover separated. FIG. 2 is an exploded perspective view schematically illustrating the camera module shown in FIG. 1.

Referring to FIG. 1 and FIG. 2, a camera module 10 according to the present embodiment includes a lens barrel 11, a lens driving apparatus 13 configured to move the lens barrel 11, an image sensor unit 17 configured to convert light incident through the lens barrel 11 into an electric signal, and a cover 15.

The lens barrel 11 may have a hollow cylindrical shape so that a plurality of lenses for capturing an image of a subject may be accommodated therein, and the plurality of lenses are mounted in the lens barrel 11 along an optical axis. A number of the plurality of lenses is as many as necessary according to a design of the lens barrel 11, and each lens may have the same or different optical properties, such as a refractive index.

The optical axis may be set to a central axis of the lenses accommodated in the lens barrel 11, and an optical axis direction means a direction parallel to this central axis. In the drawings, the optical axis is set as the z-axis, and a first direction and a second direction are set as directions perpendicular to the optical axis (z-axis). The first direction and the second direction are perpendicular to each other. In the present embodiment, for better understanding and ease of description, the first direction is defined as the x-axis of the drawing and the second direction is defined as the y-axis of the drawing. The x-axis and the y-axis are perpendicular to each other, and an x-y plane formed by the x-axis and the y-axis is a plane perpendicular to the optical axis (z-axis).

The lens barrel 11 may be accommodated in a lens holder 141, and the lens holder 141 may be accommodated in a carrier 143. The lens holder 141 has a central opening into which the lens barrel 11 may be inserted, and the lens barrel 11 is coupled to and fixed to the lens holder 141 through the central opening. The lens holder 141 and the carrier 143 may be accommodated in a housing 145 together. For example, the lens holder 141 may be provided in a frame shape having four corners. The housing 145 may have a frame shape having a central opening and having four corners. The center opening of the lens holder 141 and the center opening of the housing 145 may be aligned in the optical axis direction.

As an example, the lens holder 141 may be configured to be movable in the optical axis direction (z-axis direction) or the first direction (x-axis direction) relative to the carrier 143. In addition, the carrier 143 may be configured to be movable in the second direction (y-axis direction) relative to the housing 145. The lens driving apparatus 13 may include a first frame 14 configured to accommodate the lens barrel 11, a first optical image stabilization (OIS) driver 132 connected to the first frame 14 and configured to move the first frame 14 in the first direction (x-axis direction), and a second OIS driver 134 connected to the first frame 14 and configured to move the first frame 14 in the second direction (y-axis direction). Although FIG. 2 shows the carrier 143 as the first frame 14, the first frame 14 is not limited thereto. For example, the first frame 14 may be the lens holder 141, which also falls within the scope of the present disclosure.

In addition, the lens driving apparatus 13 may include an AF driver 136 that is directly or indirectly connected to the lens barrel 11 and configured to move the lens barrel 11 in the optical axis direction (z-axis direction).

The first OIS driver 132 may provide a driving force to move the first frame 14 in the first direction (x-axis direction) perpendicular to the optical axis direction (z-axis direction), and the second OIS driver 134 may provide a driving force to move the first frame 14 in the second direction (y-axis direction) perpendicular to the optical axis direction (z-axis direction) and perpendicular to the first direction (x-axis direction). Therefore, the first and second OIS drivers 132 and 134 move the lens barrel 11 in directions (x-axis direction and y-axis direction) perpendicular to the optical axis by driving the first frame 14 to compensate for hand shaking or swaying.

The lens driving apparatus 13 of the present embodiment may include a supporting frame 144 disposed between the carrier 143 and the housing 145. In addition, a plurality of ball assemblies 162 and 164 supporting the carrier 143, the supporting frame 144, and the housing 145 may be provided.

The supporting frame 144 may have a space into which the lens barrel 11 may be inserted. The supporting frame 144 may have a rectangular frame structure corresponding to the shape of the housing 145 provided in a frame shape having four corners.

The plurality of ball assemblies 162 and 164 serve to guide the supporting frame 144 and the carrier 143 in the shake correction process. In addition, they also serve to maintain a predetermined distance between the housing 145 and the supporting frame 144, and a predetermined distance between the supporting frame 144 and the carrier 143.

The plurality of ball assemblies 162 and 164 include a first ball assembly 162 and a second ball assembly 164. The first ball assembly 162 guides movement of the first frame 14 in the first direction (x-axis direction) by the first OIS driver 132, and the second assembly 164 guides movement of the first frame 14 in the second direction (y-axis direction) by the second OIS driver 134. The first ball assembly 162 includes a plurality of balls disposed between the carrier 143 and the supporting frame 144, and the second ball assembly 164 includes a plurality of balls disposed between the supporting frame 144 and the housing 145.

A first guide groove assembly 1442 configured to accommodate the first ball assembly 162 is formed on surfaces of the carrier 143 and the supporting frame 144 facing each other in the optical axis direction (z-axis direction). The first guide groove assembly 1442 includes a plurality of guide grooves. The first ball assembly 162 is inserted between the carrier 143 and the supporting frame 144 and accommodated in the first guide groove assembly 1442. While accommodated in the first guide groove assembly 1442, the first ball assembly 162 is prevented from moving in the optical axis direction (z-axis direction) and the second direction (y-axis direction), and may only move in the first direction (x-axis direction).

A second guide groove assembly 1452 configured to accommodate the second ball assembly 164 is formed on surfaces of the supporting frame 144 and the housing 145 facing each other in the optical axis direction (z-axis direction). The second guide groove assembly 1452 includes a plurality of guide grooves. The second ball assembly 164 is inserted between the supporting frame 144 and the housing 145 and accommodated in the second guide groove assembly 1452. While accommodated in the second guide groove assembly 1452, the second ball assembly 164 is prevented from moving in the optical axis direction (z-axis direction) and the first direction (x-axis direction), and may only move in the second direction (y-axis direction).

The image sensor unit 17 may convert light incident through the lens barrel 11 into an electrical signal. For example, the image sensor unit 17 may include an image sensor 171 and a first circuit board 173 connected thereto, and may further include an infrared filter (not shown). The first circuit board 173 may include a circuit board having wiring patterns that may be electrically connected, such as a rigid printed circuit board (rigid PCB), a flexible printed circuit board (flexible PCB), a rigid flexible printed circuit board (rigid flexible PCB), and other types of circuit boards. The infrared filter may serve to block light in an infrared region in the light incident through the lens barrel 11.

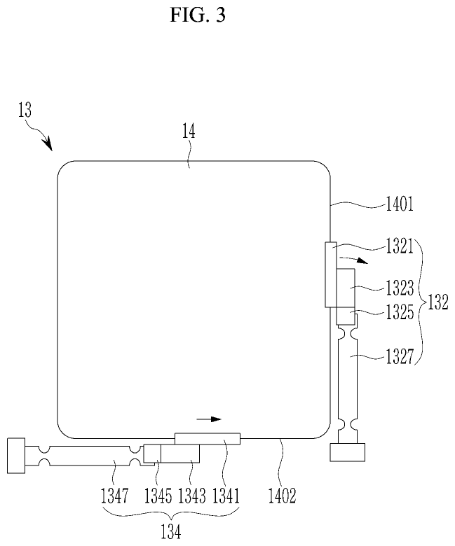

FIG. 3 is a schematic view illustrating an OIS driver of the camera module shown in FIG. 2.

Referring to FIG. 3, the first frame 14 and a second frame 16 of FIG. 2 may be connected to the first and second OIS drivers 132 and 134, and the first frame 14 may be accommodated in the second frame 16. FIG. 3 shows the first frame 14 and parts of the second frame 16. The first OIS driver 132 may include a first frictional contact portion 1321, a first rod 1323 in contact with the first frictional contact portion 1321, a first piezoelectric element 1325 having a first end connected to the first rod 1323, and a first hinge member 1327 connected to a second end of the first piezoelectric element 1325. The second OIS driver 134 may include a second frictional contact portion 1341, a second rod 1343 in contact with the second frictional contact portion 1341, a second piezoelectric element 1345 having a first end connected to the second rod 1343, and a second hinge member 1347 connected to a second end of the second piezoelectric element 1345.

The first and second frictional contact portions 1321 and 1341 may be disposed on the first frame 14. The first frictional contact portion 1321 and the second frictional contact portion 1341 may be disposed to provide frictional forces in different directions. Directions of frictional forces provided by the first frictional contact portion 1321 and the second frictional contact portion 1341 may be perpendicular to each other. The first frictional contact portion 1321 and the second frictional contact portion 1341 may be disposed to be perpendicular to each other. For example, the first frictional contact portion 1321 may provide a frictional force in a direction opposite to the movement of the first rod 1323 in the first direction (x-axis direction). In addition, the second frictional contact portion 1341 may provide a frictional force in a direction opposite to the movement of the second rod 1343 in the second direction (y-axis direction).

The first frictional contact portion 1321 and the second frictional contact portion 1341 may be disposed on a first contact surface 1401 and a second contact surface 1402 of the first frame 14, respectively, and the first contact surface 1401 and the second contact surface 1402 may be perpendicular to each other. In addition, each of the first contact surface 1401 and the second contact surface 1402 may be perpendicular to the optical axis direction (z-axis direction). For example, a length direction of the first frictional contact portion 1321 may be parallel to the first direction (x-axis direction), and a length direction of the second frictional contact portion 1341 may be parallel to the second direction (y-axis direction). Also, the first contact surface 1401 may be parallel to the first direction (x-axis direction), and the second contact surface 1402 may be parallel to the second direction (y-axis direction).

The first and second piezoelectric elements 1325 and 1345 may contract and expand in a direction perpendicular to the optical axis. The first and second piezoelectric elements 1325 and 1345 may include a material that generates a mechanical deformation in response to an applied voltage. For example, in response to the applied voltage, the first piezoelectric element 1325 may generate a mechanical deformation in the first direction (x-axis direction) to thereby generate a vibration in the first direction (x-axis direction), and the second piezoelectric element 1345 may generate a mechanical deformation in the second direction (y-axis direction) to thereby generate a vibration in the first direction (x-axis direction).

The first and second piezoelectric elements 1325 and 1345 may have a shape that is elongated in one direction. The first piezoelectric element 1325 and the second piezoelectric element 1345 may be disposed to be perpendicular to each other, and whether the first piezoelectric element 1325 and the second piezoelectric element 1345 are disposed perpendicular to each other may be determined based on directions in which the first piezoelectric element 1325 and the second piezoelectric element 1345 are elongated. For example, the first piezoelectric element 1325 may be elongated in the first direction (x-axis direction), and the second piezoelectric element 1345 may be elongated in the second direction (y-axis direction).

The first rod 1323 may be connected to a first end of the first piezoelectric element 1325. In addition, the first rod 1323 may be connected to the first frame 14. The first rod 1323 may be in contact with the first frictional contact portion 1321 and connected to the first frame 14. The first rod 1323 may transfer the vibration generated by the first piezoelectric element 1325 to the first frame 14.

The second rod 1343 may be connected to a first end of the second piezoelectric element 1345. In addition, the second rod 1343 may be connected to the first frame 14. The second rod 1343 may be in contact with the second frictional contact portion 1341 and connected to the first frame 14. The second rod 1343 may transfer the vibration generated by the second piezoelectric element 1345 to the first frame 14.

According to the vibration directions of the first and second rods 1323 and 1343, the first frame 14 may move in the first direction (x-axis direction) and the second direction (y-axis direction). As a result of this, the lens barrel 11 may move in the first direction (x-axis direction) and the second direction (y-axis direction), and the lens accommodated in the lens barrel 11 may also move to compensate for hand shake or swaying.

The first and second rods 1323 and 1343 may be in contact with the first and second frictional contact portions 1321 and 1341, respectively, so that the first and second rods 1323 and 1343 are connected to the first frame 14. Even when the first frame 14 moves, the first and second rods 1323 and 1343 may always maintain contact with the first and second frictional contact portions 1321 and 1341, respectively. For example, even when the first frame 14 moves in the first direction (x-axis direction), the second rod 1343 may maintain contact with the second frictional contact portion 1341, and even when the first frame 14 moves in the second direction (y-axis direction), the first rod 1323 may maintain contact with the first frictional contact portion 1321.

The first and second piezoelectric elements 1325 and 1345 may vibrate by repeating expansion and contraction rapidly or slowly according to an applied high-frequency pulse voltage. For example, when the first and second rods 1323 and 1343 connected to the first and second piezoelectric elements 1325 and 1345 rapidly expand and slowly contract, the first and second frictional contact portions 1321 and 1341 and the first frame 14 move in the contracting direction. When the first and second rods 1323 and 1343 rapidly expand, the static inertia is larger than the frictional force between the first and second frictional contact portions 1321 and 1341 and the first and second rods 1323 and 1343, and the first and second frictional contact portions 1321 and 1341 do not move. When the first and second rods 1323 and 1343 slowly contract, the frictional force between the first and second frictional contact portions 1321 and 1341 and the first and second rods 1323 and 1343 is larger than the static inertia, and the first and second frictional contact portions 1321 and 1341 move in a contraction direction of the first and second rods 1323 and 1343. At this time, the first frame 14 connected to the first and second frictional contact portions 1321 and 1341 also moves.

In the same way, when the first and second rods 1323 and 1343 connected to the first and second piezoelectric elements 1325 and 1345 rapidly contract and slowly expand, the first and second frictional contact portions 1321 and 1341 and the first frame 14 may move in the expanding direction.

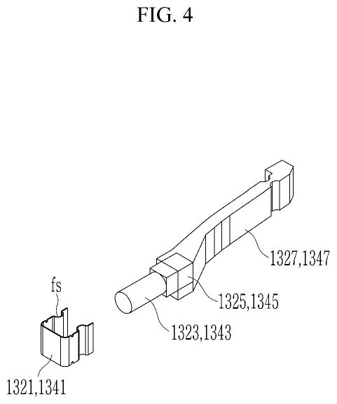

FIG. 4 is a partial exploded view illustrating first and second OIS drivers of the camera module shown in FIG. 2.

Referring to FIG. 4, the first and second frictional contact portions 1321 and 1341 may include a friction clamp. Even when the first frame 14 moves, the first and second frictional contact portions 1321 and 1341 including the friction clamp may provide pressure to the first and second rods 1323 and 1343 in order to maintain contact between the first and second frictional contact portions 1321 and 1341 and the first and second rods 1323 and 1343. The friction clamp may include a locking part fs.

A first end of the first hinge member 1327 may be connected to the second end of the first piezoelectric element 1325. A second end of the first hinge member 1327 may be connected to the second frame 16 accommodating the first frame 14. The first hinge member 1327 may be fixed to the second frame 16, and when the second OIS driver 134 provides a driving force in the second direction (y-axis direction), the first hinge member 1327 may provide a torque to maintain contact between the first rod 1323 and the first frictional contact 1321.

A first end of the second hinge member 1347 may be connected to the second end of the second piezoelectric element 1345. A second end of the second hinge member 1347 may be connected to the second frame 16 accommodating the first frame 14. The second hinge member 1347 may be fixed to the second frame 16, and when the first OIS driver 132 provides a driving force in the first direction (x-axis direction), the second hinge member 1347 may provide a torque to maintain contact between the second rod 1343 and the second frictional contact portion 1341.

The first and second hinge members 1327 and 1347 may include one or more wires so as to be easily deformable, and may be made of an injection-molded product including one or more wires or a metal plate. The first and second hinge members 1327 and 1347 may include a metal-based material having a high rigidity. In addition, the first and second hinge members 1327 and 1347 may be assembled to the first frame 14 in a pivotal manner so as to facilitate rotation. For example, the first and second hinge members 1327 and 1347 may include one or more wires, and the rotational force provided by the first and second hinge members 1327 and 1347 may be due to deformation of the one or more wires.

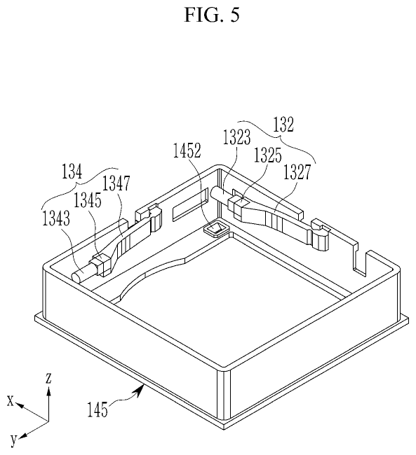

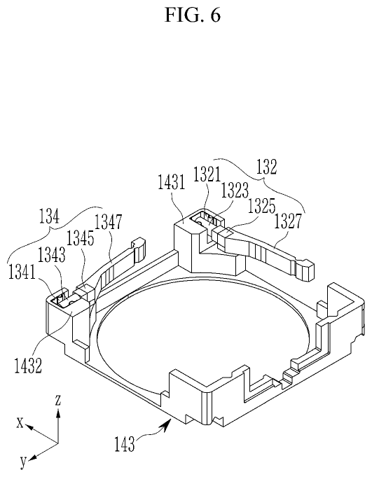

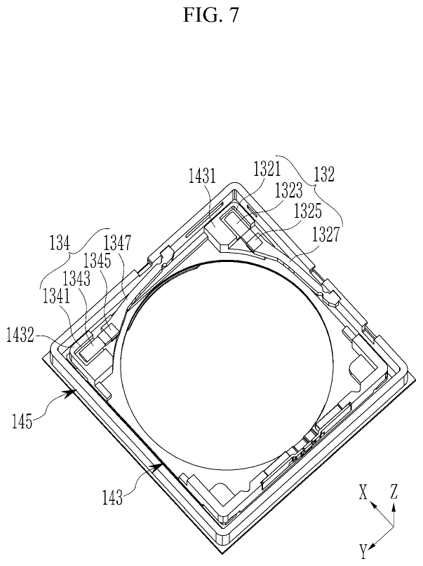

FIG. 5 is a perspective view showing a part where the housing of the camera module and the OIS driver shown in FIG. 2 are coupled. FIG. 6 is a perspective view showing a part where the carrier of the camera module and the OIS driver shown in FIG. 2 are coupled. FIG. 7 is a perspective view showing a part where the housing and the carrier of the camera module and the OIS driver shown in FIG. 2 are coupled.

As an example, referring to FIG. 5 to FIG. 7, in the present embodiment, the first frame 14 may be the carrier 143 accommodating the lens holder 141, and the second frame 16 may be the housing 145 accommodating the carrier 143.

The first and second frictional contact portions 1321 and 1341 may be connected to the carrier 143. The first and second frictional contact portions 1321 and 1341 may be coupled to first and second accommodation portions 1431 and 1432 disposed in the carrier 143. The first and second frictional contact portions 1321 and 1341 may be fixed to the first and second accommodation portions 1431 and 1432, respectively, and may be in contact with the first and second rods 1323 and 1343, respectively, to provide the frictional force. The first and second frictional contact portions 1321 and 1341 may be disposed in edge portions of the carrier 143, and may be coupled to the first and second accommodation portions 1431 and 1432 disposed in the edge portions of the carrier 143.

As an example, the first and second frictional contact portions 1321 and 1341 may be clamps that apply pressure to the first and second rods 1323 and 1343 in both directions, respectively. The first and second accommodation portions 1431 and 1432 may have a groove shape accommodating the clamps. A groove of the first accommodation portion 1431 accommodating the first frictional contact portion 1321 may extend parallel to the first direction (x-axis direction), and a groove of a second accommodation portion 1432 accommodating the second frictional contact portion 1341 may extend parallel to the second direction (y-axis direction). The first frictional contact portion 1321 and the first accommodation portion 1431 may be coupled in the first direction (x-axis direction), and the second frictional contact portion 1341 and the second accommodation portion 1432 may be coupled in the second direction (y-axis direction).

The first frictional contact portion 1321 may maintain contact with the first rod 1323 by applying pressure to both sides of the first rod 1323 in the second direction (y-axis direction). The first frictional contact portion 1321 may provide frictional force in the first direction (x-axis direction) to the first rod 1323. The second frictional contact portion 1341 may maintain contact with the second rod 1343 by applying pressure to both sides of the second rod 1343 in the first direction (x-axis direction). The second frictional contact portion 1341 may provide frictional force in the second direction (y-axis direction) to the second rod 1343.

As an example, the first and second frictional contact portions 1321 and 1341 may be clamp-shaped friction clamps, and the first and second accommodation portions 1431 and 1432 may be grooves in which the clamp-shaped friction clamps constituting the first and second frictional contact portions 1321 and 1341 may be at least partially accommodated.

The first frictional contact portion 1321 and the second frictional contact portion 1341 may be disposed to be perpendicular to each other. The first frictional contact portion 1321 and the second frictional contact portion 1341 may be disposed on a first contact surface 1401 and a second contact surface 1402 of the first frame 14, respectively, and the first contact surface 1401 and the second contact surface 1402 may be perpendicular to each other. In addition, each of the first contact surface 1401 and the second contact surface 1402 may be perpendicular to the optical axis direction (z-axis direction). For example, a length direction of the first frictional contact portion 1321 may be parallel to the first direction (x-axis direction), and a length direction of the second frictional contact portion 1341 may be parallel to the second direction (y-axis direction). Also, the first contact surface 1401 may be parallel to the first direction (x-axis direction), and the second contact surface 1402 may be parallel to the second direction (y-axis direction).

The first rod 1323 may be connected to the first end of the first piezoelectric element 1325 and transfer a vibration of the first piezoelectric element 1325 to the carrier 143. The first rod 1323 may be in contact with the first frictional contact portion 1321. Even when the carrier 143 moves, the first rod 1323 may maintain contact with the first frictional contact portion 1321. For example, even when the carrier 143 moves in the second direction (y-axis direction), the first rod 1323 may maintain contact with the first frictional contact portion 1321.

As an example, the first rod 1323 may receive pressure in two directions opposing each other in the second direction (y-axis direction) from the first frictional contact portion 1321 of the clamp shape. The first rod 1323 may be in contact with the first frictional contact portion 1321 and may be at least partially accommodated in the first accommodation portion 1431.

The second rod 1343 may be connected to the first end of the second piezoelectric element 1345 and transfer a vibration of the second piezoelectric element 1345 to the carrier 143. The second rod 1343 may be in contact with the second frictional contact portion 1341. Even when the carrier 143 moves, the second rod 1343 may maintain contact with the second frictional contact portion 1341. For example, even when the carrier 143 moves in the first direction (x-axis direction), the second rod 1343 may maintain contact with the second frictional contact portion 1341.

As an example, the second rod 1343 may receive pressure in two directions opposing each other in the first direction (x-axis direction) from the second frictional contact portion 1341 of the clamp shape. The second rod 1343 may be in contact with the second frictional contact portion 1341 and may be at least partially accommodated in the second accommodation portion 1432.

The first rod 1323 and the second rod 1343 may be disposed to be perpendicular to each other. For example, a length direction of the first rod 1323 may be parallel to the first direction (x-axis direction), and a length direction of the second rod 1343 may be parallel to the second direction (y-axis direction). The first rod 1323 and the second rod 1343 may have a long rod-like structure, or may have a circular or rectangular pillar shape, but are not limited thereto.

The first piezoelectric element 1325 may contract and expand in the first direction (x-axis direction) by generating a mechanical deformation in response to an applied voltage. The first rod 1323 is fixed to the first end of the first piezoelectric element 1325, and may transfer a vibration due to contraction and expansion of the first piezoelectric element 1325 in the first direction (x-axis direction) to the carrier 143. As the first piezoelectric element 1325 vibrates in the first direction (x-axis direction), the first rod 1323 also vibrates in the first direction (x-axis direction). Due to the vibration of the first rod 1323, the first frictional contact portion 1321 moves in the first direction (x-axis direction). The carrier 143 moves in the first direction (x-axis direction) in response to the movement of the first frictional contact portion 1321, and the lens barrel 11 accommodated in the carrier 143 also moves in the first direction (x-axis direction).

The second piezoelectric element 1345 may contract and expand in the second direction (y-axis direction) by generating a mechanical deformation in response to an applied voltage. The second rod 1343 is fixed to the first end of the second piezoelectric element 1345, and may transfer a vibration due to contraction and expansion of the second piezoelectric element 1345 in the second direction (y-axis direction) to the carrier 143. As the second piezoelectric element 1345 vibrates in the second direction (y-axis direction), the second rod 1343 also vibrates in the second direction (y-axis direction). Due to the vibration of the second rod 1343, the second frictional contact portion 1341 moves in the second direction (y-axis direction). The carrier 143 moves in the second direction (y-axis direction) in response to the movement of the second frictional contact portion 1341, and the lens barrel 11 accommodated in the carrier 143 also moves in the second direction (y-axis direction).

A first end of the first hinge member 1327 may be connected to the second end of the first piezoelectric element 1325. A second end of the first hinge member 1327 may be connected to the housing 145. The first hinge member 1327 may extend in the first direction (x-axis direction) from the second end of the first piezoelectric element 1325. The first hinge member 1327 may be bent perpendicular to the first direction (x-axis direction) in which the first hinge member 1327 extends and connected to the housing 145. The first hinge member 1327 may be coupled to a portion of the housing 145 parallel to the first direction (x-axis direction). The first hinge member 1327 may be deformed to be bent or provide a torque about an axis parallel to the optical axis (z-axis) toward the carrier 143. When the distance between the carrier 143 and the housing 145 changes as the carrier 143 moves in the second direction (y-axis direction), the first hinge member 1327 may be deformed to be bent or provide a torque to maintain contact between the first frictional contact portion 1321 and the first rod 1323.

A first end of the second hinge member 1347 may be connected to the second end of the second piezoelectric element 1345. A second end of the second hinge member 1347 may be connected to the housing 145. The second hinge member 1347 may extend in the second direction (y-axis direction) from the second end of the second piezoelectric element 1345. The second hinge member 1347 may be bent perpendicular to the second direction (y-axis direction) in which the second hinge member 1347 extends and connected to the housing 145. The second hinge member 1347 may be coupled to a portion of the housing 145 parallel to the second direction (y-axis direction). The second hinge member 1347 may be deformed to be bent or provide a parallel to the optical axis (z-axis) toward the carrier 143. When the distance between the carrier 143 and the housing 145 changes as the carrier 143 moves in the first direction (x-axis direction), the second hinge member 1347 may be deformed to be bent or provide a torque to maintain contact between the second frictional contact portion 1341 and the second rod 1343.

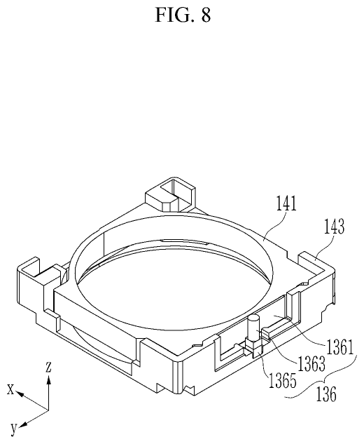

FIG. 8 is a perspective view of a part where the carrier and the lens holder of the camera module and the AF driver shown in FIG. 2 are coupled.

Referring to FIG. 8, the AF driver 136 may provide a driving force to move the lens holder 141 in the optical axis direction (z-axis direction). The AF driver 136 may adjust the focus by moving the lens barrel 11 in the optical axis direction (z-axis direction) by driving the lens holder 141. The AF driver 136 may include a third frictional contact portion 1361, a third rod 1363, and a third piezoelectric element 1365.

The third frictional contact portion 1361 may be disposed on the lens holder 141 and may be attached to an outer surface of the lens holder 141. The third frictional contact portion 1361 may be disposed to provide a frictional force in the optical axis direction (z-axis direction).

The third piezoelectric element 1365 may be connected to the carrier 143. The third piezoelectric element 1365 may have a shape that is elongated in the optical axis direction. The third piezoelectric element 1365 may contract and expand in the optical axis direction (z-axis direction) by generating a mechanical deformation in response to an applied voltage, thereby generating a vibration. The third piezoelectric element 1365 may have a first end connected to the carrier 143 and a second end connected to the third rod 1363.

The third rod 1363 has a first end connected to the third piezoelectric element 1365 and is in contact with the third frictional contact portion 1361. The third rod 1363 may transfer a vibration due to expansion and contraction of the third piezoelectric element 1365 in the optical axis direction (z-axis direction) to the lens holder 141. As the third piezoelectric element 1365 vibrates in the optical axis direction (z-axis direction), the third rod 1363 also vibrates in the optical axis direction (z-axis direction). Due to the vibration of the third rod 1363, the third frictional contact portion 1361 moves in the optical axis direction (z-axis direction). The lens holder 141 moves in the optical axis direction (z-axis direction) in response to the movement of the third frictional contact portion 1361, and the lens barrel 11 accommodated in the lens holder 141 also moves in the optical axis direction (z-axis direction).

The third piezoelectric element 1365 may vibrate while repeating expansion and contraction rapidly or slowly according to an applied high-frequency pulse voltage. For example, when the third rod 1363 connected to the third piezoelectric element 1365 rapidly expands and slowly contracts, the third frictional contact portion 1361 and the lens holder 141 move in the contracting direction. When the third rod 1363 rapidly expands, the static inertia is larger than the frictional force between the third frictional contact portion 1361 and the third rod 1363, and the third frictional contact portion 1361 does not move. When the third rod 1363 slowly contracts, the frictional force between the third frictional contact portion 1361 and the third rod 1363 is larger than the static inertia, and the third frictional contact portion 1361 moves in a contraction direction of the third rod 1363. At this time, the lens holder 141 connected to the third frictional contact portion 1361 also moves.

Although not shown in the drawings, each of the first OIS driver 132, the second OIS driver 134, and the AF driver 136 may further include a weight member for adjusting a resonance frequency thereof.

In the present embodiment, a second circuit board 19 shown in FIG. 2 may be included. The second circuit board 19 may apply voltages to the first to third piezoelectric elements 1325, 1345, and 1365. The second circuit board 19 may maintain a power supply even when the first frame 14 or the first to third piezoelectric elements 1325, 1345, and 1365 move. The second circuit board 19 may include a circuit board having wiring patterns that may be electrically connected, such as a flexible printed circuit board or a rigid flexible printed circuit board.

In addition, the second circuit board 19 may be connected to a position sensor unit (not shown) to apply power to the position sensor unit. The position sensor unit may be electrically connected to the second circuit board 19. For example, the second circuit board 19 may have a doubly bent shape, i.e., a C-shape or a U-shape. The position sensor unit may detect the position of the lens barrel 11 in the optical axis direction (z-axis direction), the first direction (x-axis direction), and the second direction (y-axis direction).

The cover 15 is coupled to the housing 145 to surround an outer surface of the housing 145 and protect internal components of the camera module 10. In addition, the cover 15 may function to shield electromagnetic waves. For example, the cover 15 may shield electromagnetic waves so that electromagnetic waves generated by the camera module 10 do not affect other electronic components in an electronic device in which the camera module 10 is mounted. For example, the cover 15 may be a metal shield can.

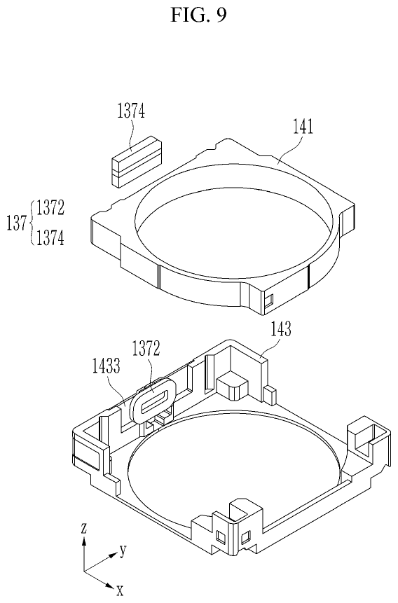

FIG. 9 is a partially exploded perspective view illustrating a lens holder, a carrier, and an AF driver to describe a camera module according to another embodiment.

The embodiment shown in FIG. 9 is substantially the same as the embodiments shown in FIG. 1 to FIG. 8 except for the AF driver, so repeated descriptions are not provided herein.

Referring to FIG. 9, an AF driver 137 of the camera module 10 according to the present embodiment may include an AF driving coil 1372 and an AF driving magnet 1374 disposed to face each other. The AF driving magnet 1374 may be fixed to a side surface of the lens holder 141. The AF driving coil 1372 may be fixed to the carrier 143 via a coil substrate 1433.

When power is applied to the AF driving coil 1372, the lens holder 141 may be moved in the optical axis direction (z-axis direction) by an electromagnetic interaction between the AF driving magnet 1374 and the AF driving coil 1372. Since the lens barrel 11 is accommodated in the lens holder 141, the focus may be adjusted as the lens barrel 11 is also moved in the optical axis direction (z-axis direction) by the movement of the lens holder 141.

The AF driving magnet 1374 is a movable member mounted on the lens holder 141 and movable in the optical axis direction (z-axis direction) together with the lens holder 141, and the AF driving coil 1372 is a fixed member fixed to the carrier 143. However, the AF driver 137 is not limited to this configuration, and it is possible to exchange positions of the AF driving coil 1372 and the AF driving magnet 1374, which also falls within the scope of the present disclosure.

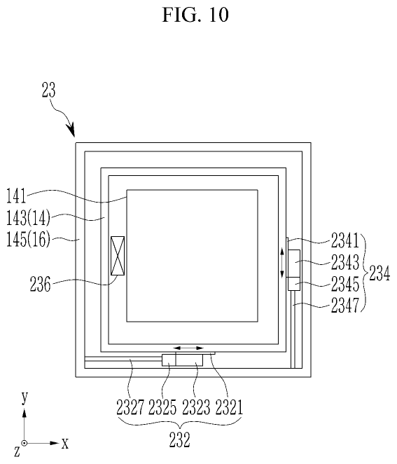

FIG. 10 illustrates a camera module according to another embodiment.

The embodiment shown in FIG. 10 is substantially the same as the embodiments shown in FIG. 1 to FIG. 9 except for the lens driving apparatus 13, so repeated descriptions are not provided herein.

Referring to FIG. 10, a lens driving apparatus 23 of a camera module according to the present embodiment may include the first frame 14, a first OIS driver 232 configured to move the first frame 14 in the first direction (x-axis direction), and a second OIS driver 234 configured to move the first frame 14 in the second direction (y-axis direction).

The first OIS driver 232 may include a first frictional contact portion 2321, a first rod 2323 in contact with the first frictional contact portion 2321, a first piezoelectric element 2325 having a first end connected to the first rod 2323, and a first hinge member 2327 having a first end connected to a second end of the first piezoelectric element 2325 and a second end connected to the second frame 16 accommodating the first frame 14.

The second OIS driver 234 may include a second frictional contact portion 2341, a second rod 2343 in contact with the second frictional contact portion 2341, a second piezoelectric element 2345 having a first end connected to the second rod 2343, and a second hinge member 2347 having a first end connected to a second end of the second piezoelectric element 2345 and a second end connected to the second frame 16.

In the present embodiment, the first frame 14 may be the carrier 143 accommodating the lens holder 141, and the second frame 16 may be the housing 145 accommodating the carrier 143.

The first frictional contact portion 2321 and the second frictional contact portion 2341 may be connected to different surfaces of the carrier 143, respectively. The first frictional contact portion 2321 and the second frictional contact portion 2341 may be disposed to be perpendicular to each other. For example, the first frictional contact portion 2321 may be attached to a surface of the carrier 143 parallel to the first direction (x-axis direction), and the second frictional contact portion 2341 may be attached to a surface of the carrier 143 parallel to the second direction y-axis direction). The first frictional contact portion 2321 and the second frictional contact portion 2341 are in contact with the first rod 2323 and the second rod 2343, respectively, and even when the distance between the carrier 143 and the housing 145 changes, this contact may be maintained.

The first hinge member 2327 and the second hinge member 2347 may have their first ends connected to the first piezoelectric element 2325 and the second piezoelectric element 2345, respectively, and their second ends connected to the housing 145. The first hinge member 2327 and the second hinge member 2347 may be disposed to be perpendicular to each other. For example, the first hinge member 2327 may be connected to a surface of the housing 145 parallel to the second direction (y-axis direction), and the second hinge member 2347 may be connected to a surface of the housing 145 parallel to the first direction (x-axis direction). The first hinge member 2327 may be deformed to be bent or provide a torque about an axis parallel to the optical axis (z-axis) toward the carrier 143, and maintain contact between the first frictional contact portion 2321 and the first rod 2323. The second hinge member 2347 may be deformed to be bent or provide a torque about an axis parallel to the optical axis (z-axis) toward the carrier 143, and maintain contact between the second frictional contact portion 2341 and the second rod 2343.

An AF driver 236 may be the same as the AF driver 136 shown in FIG. 8, and may include a third frictional contact portion disposed on the lens holder 141, a third piezoelectric element configured to vibrate in the optical axis direction (z-axis direction) and having a first end connected to the carrier 143 accommodating the lens holder 145, and a third rod in contact with the third frictional contact portion and having a first end connected to a second end of the third piezoelectric element. The third frictional contact portion may be attached to an outer surface of the lens holder 141.

As another example, the AF driver 236 may be the same as the AF driver 137 shown in FIG. 9, and may include an AF driving coil and an AF driving magnet disposed to face each other. The AF driving coil and the AF driving magnet may be fixed to the lens holder 141 and the carrier 143, respectively, or to the carrier 143 and the lens holder 141, respectively.

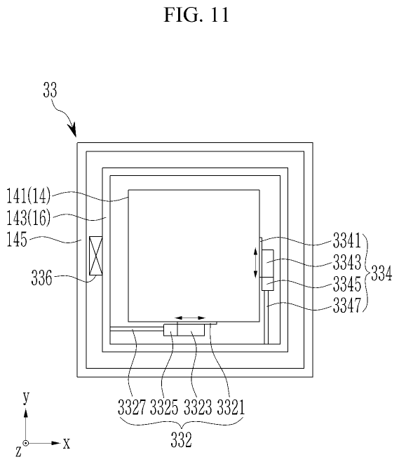

FIG. 11 illustrates a camera module according to another embodiment.

The embodiment shown in FIG. 11 is substantially the same as the embodiments shown in FIG. 1 to FIG. 10 except for the lens driving apparatuses 13 and 23, so repeated descriptions are not provided herein.

Referring to FIG. 11, a lens driving apparatus 33 of a camera module according to the present embodiment may include the first frame 14, a first OIS driver 332 configured to move the first frame 14 in the first direction (x-axis direction), and a second OIS driver 334 configured to move the first frame 14 in the second direction (y-axis direction).

The first OIS driver 332 may include a first frictional contact portion 3321, a first rod 3323 in contact with the first frictional contact portion 3321, a first piezoelectric element 3325 having a first end connected to the first rod 3323, and a first hinge member 3327 having a first end connected to a second end of the first piezoelectric element 3325 and a second end connected to the second frame 16 accommodating the first frame 14. The second OIS driver 334 may include a second frictional contact portion 3341, a second rod 3343 in contact with the second frictional contact portion 3341, a second piezoelectric element 3345 having a first end connected to the second rod 3343, and a second hinge member 3347 having a first end connected to a second end of the second piezoelectric element 3345 and a second end is connected to the second frame 16.

In the present embodiment, the first frame 14 may be the lens holder 141, and the second frame 16 may be the carrier 143 accommodating the lens holder 141. In contrast, in the embodiments shown in FIGS. 1-10, the first frame 14 may be the carrier 143, and the second frame 16 may be the housing 145 accommodating the carrier 143.

The first frictional contact portion 3321 and the second frictional contact portion 3341 may be connected to different surfaces of the lens holder 141, respectively. The first frictional contact portion 3321 and the second frictional contact portion 3341 may be disposed to be perpendicular to each other. For example, the first frictional contact portion 3321 may be attached to a surface of the lens holder 141 parallel to the first direction (x-axis direction), and the second frictional contact portion 3341 may be attached to a surface of the lens holder 141 parallel to the second direction (y-axis direction). The first frictional contact portion 3321 and the second frictional contact portion 3341 are in contact with the first rod 3323 and the second rod 3343, respectively, and even when the distance between the lens holder 141 and the carrier 143 changes, this contact may be maintained.

The first hinge member 3327 and the second hinge member 3347 may have their first ends connected to the first piezoelectric element 2325 and the second piezoelectric element 2345, respectively, and their second ends connected to the carrier 143. The first hinge member 3327 and the second hinge member 3347 may be disposed to be perpendicular to each other. For example, the first hinge member 3327 may be connected to a surface of the carrier 143 parallel to the second direction (y-axis direction), and the second hinge member 3347 may be connected to a surface of the carrier 143 parallel to the first direction (x-axis direction). The first hinge member 3327 may be deformed to be bent or provide a torque about an axis parallel to the optical axis (z-axis) toward the lens holder 141, and maintain contact between the first frictional contact portion 3321 and the first rod 3323. The second hinge member 3347 may be deformed to be bent or provide a torque about an axis parallel to the optical axis (z-axis) toward the lens holder 141, and maintain contact between the second frictional contact portion 3341 and the second rod 3343.

An AF driver 336 may be substantially the same as the AF driver 136 shown in FIG. 8, and may include a third frictional contact portion disposed on the carrier 143, a third piezoelectric element configured to vibrate in the optical axis direction (z-axis direction) and having a first end connected to the housing 145 accommodating the carrier 143, and a third rod in contact with the third frictional contact portion and having a first end connected to a second end of the third piezoelectric element. The third frictional contact portion may be attached to an outer surface of the carrier 143.

As another example, the AF driver 336 may be substantially the same as the AF driver 137 shown in FIG. 9, and may include an AF driving coil and an AF driving magnet disposed to face each other. The AF driving coil and the AF driving magnet may be fixed to the carrier 143 and the housing 145, respectively, or to the housing 145 and the carrier 143, respectively.

According to a lens driving apparatus of the embodiments described above, by using a piezoelectric element as a lens driving apparatus for a camera module, power consumption may be improved even when the weight and size of a lens increases, and driving defects due to magnetic field interference may be prevented by preventing magnetic field interference.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and are not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens driving apparatus comprising:
a first frame accommodating a lens;
a first optical image stabilization (OIS) driver comprising a first frictional contact portion disposed on the first frame, a first piezoelectric element configured to vibrate in a first direction, and a first rod connected to a first end of the first piezoelectric element, in contact with the first frictional contact portion, and configured to move the first frame in the first direction; and
a second OIS driver comprising a second frictional contact portion disposed on the first frame, a second piezoelectric element configured to vibrate in a second direction different from the first direction, and a second rod connected to a first end of the second piezoelectric element, in contact with the second frictional contact portion, and configured to move the first frame in the second direction.

2. The lens driving apparatus of claim 1, wherein the first frictional contact portion is disposed on a first contact surface of the first frame, and the second frictional contact portion is disposed on a second contact surface of the first frame, and
the first contact surface and the second contact surface are perpendicular to each other.

3. The lens driving apparatus of claim 2, wherein the first contact surface is parallel to the first direction, and the second contact surface is parallel to the second direction.

4. The lens driving apparatus of claim 1, wherein the first OIS driver further comprises a first hinge member having a first end connected to a second end of the first piezoelectric element, and a second end connected to a second frame accommodating the first frame, and
the second OIS driver further comprises a second hinge member having a first end connected to a second end of the second piezoelectric element, and a second end connected to the second frame.

5. The lens driving apparatus of claim 4, further comprising a lens holder accommodating a lens barrel accommodating the lens,
wherein the first frame is a carrier accommodating the lens holder.

6. The lens driving apparatus of claim 5, wherein the second frame is a housing accommodating the carrier.

7. The lens driving apparatus of claim 6, further comprising:
a supporting frame disposed between the carrier and the housing;
a first ball assembly configured to guide movement of the carrier in the first direction by the first OIS driver;
a second ball assembly configured to guide movement of the carrier in the second direction by the second OIS driver;
a first guide groove assembly formed on surfaces of the carrier and the supporting frame facing each other having the first ball assembly disposed therein; and
a second guide groove assembly formed on surfaces of the supporting frame and the housing facing each other and having the second ball assembly disposed therein.

8. The lens driving apparatus of claim 6, wherein a second end of the first hinge member is connected to a surface of the housing parallel to the second direction, and
a second end of the second hinge member is connected to a surface of the housing parallel to the first direction.

9. The lens driving apparatus of claim 5, wherein the first frictional contact portion is coupled to a first accommodation portion disposed in a first edge portion of the carrier, and the second frictional contact portion is coupled to a second accommodation portion disposed in a second edge portion of the carrier.

10. The lens driving apparatus of claim 9, wherein each of the first frictional contact portion and the second frictional contact portion comprises a friction clamp.

11. The lens driving apparatus of claim 10, wherein each of the first accommodation portion and the second accommodation portion is a groove accommodating the friction clamp, and
the first frictional contact portion and the first accommodation portion are coupled in the first direction, and the second frictional contact portion and the second accommodation portion are coupled in the second direction.

12. The lens driving apparatus of claim 11, wherein the first hinge member is coupled to a portion of a housing parallel to the first direction, and
the second hinge member is coupled to a portion of the housing parallel to the second direction.

13. The lens driving apparatus of claim 5, further comprising an AF driver comprising:
a third frictional contact portion disposed on the lens holder;
a third rod in contact with the third frictional contact portion; and
a third piezoelectric element having a first end connected to the carrier and a second end connected to a first end of the third rod and being configured to vibrate in a direction perpendicular to the first direction and the second direction.

14. The lens driving apparatus of claim 4, wherein the first frame is a lens holder accommodating the lens barrel, and
the second frame is a carrier accommodating the lens holder.

15. The lens driving apparatus of claim 14, further comprising an AF driver comprising:
a third frictional contact portion disposed on the carrier;
a third rod in contact with the third frictional contact portion; and
a third piezoelectric element connected to a first end of the third rod and configured to vibrate in a direction perpendicular to the first direction and the second direction.

16. A camera module comprising:
a lens;
a lens barrel accommodating the lens;
a first frame accommodating the lens barrel;
a second frame accommodating the first frame;
a first OIS driver comprising a first frictional contact portion disposed on the first frame, a first piezoelectric element configured to vibrate in a first direction, a first rod connected to a first end of the first piezoelectric element, in contact with the first frictional contact portion, and configured to move the first frame in the first direction, and a first hinge member having a first end connected to a second end of the first piezoelectric element and a second end connected to the second frame; and
a second OIS driver comprising a second frictional contact portion disposed on the first frame, a second piezoelectric element configured to vibrate in a second direction different from the first direction, a second rod connected to a first end of the second piezoelectric element, in contact with the second frictional contact portion, and configured to move the first frame in the second direction, and a second hinge member having a first end connected to a second end of the second piezoelectric element and a second end connected to the second frame.

17. The camera module of claim 16, further comprising a lens holder accommodating the lens barrel,
wherein the first frame is a carrier accommodating the lens holder, and
the second frame is a housing accommodating the carrier.

18. The camera module of claim 17, wherein the first frictional contact portion is connected to a surface of the carrier parallel to the first direction, and the second frictional contact portion is connected to a surface of the carrier parallel to the second direction, and
the first hinge member is connected to a surface of the housing parallel to the first direction, and the second hinge member is connected to a surface of the housing parallel to the second direction.

19. The camera module of claim 17, wherein the first frictional contact portion is connected to a surface of the carrier parallel to the first direction, and the second frictional contact portion is connected to a surface of the carrier parallel to the second direction, and
the first hinge member is connected to a surface of the housing parallel to the second direction, and the second hinge member is connected to a surface of the housing parallel to the first direction.

20. The camera module of claim 16, wherein the first frame is a lens holder accommodating the lens barrel, and
the second frame is a carrier accommodating the lens holder.
